(19) United States
(12) Patent Application Publication
(10) Pub. No.: US 2018/0289199 A1
(43) Pub. Date: Oct. 11, 2018

(54) TURKISH COFFEE MACHINE

(71) Applicant: ARZUM ELEKTRIKLI EV ALETLERI SAN. VE TIC. A.S., Istanbul (TR)

(72) Inventor: Ersoy ATILLA, Istanbul (TR)

(21) Appl. No.: 15/575,710

(22) PCT Filed: Apr. 21, 2016
(86) PCT No.: PCT/TR2016/050120

§ 371 Date: Nov. 20, 2017

(30) Foreign Application Priority Data
May 20, 2015 (TR) 2015/06084

(51) Int. Cl. A47J 31/18; A23F 5/26

(52) U.S. Cl. CPC A47J 31/18; A23F 5/267; A23F 5/265

(57) ABSTRACT

The present invention relates to a Turkish coffee cooking and servicing machine whose inner side is heated by means of a heater (15) and having a cooking chamber (10) wherein a coffee mixture including Turkish coffee, water and optionally sugar is cooked and having a pushing head (13) defining the base of the cooking chamber (10) and which moves vertically between at least one cooking position (i) and a service position (ii) where the coffee mixture in the cooking chamber (10) is raised to the level of the discharge outlet (11) in order to transfer said coffee mixture, provided in the cooking chamber (10), to a beverage vessel through a discharge outlet (11) for servicing when the cooking is completed.

### TECHNICAL FIELD

The present invention relates to Turkish coffee cooking and servicing machines wherein Turkish coffee is cooked and serviced.

### PRIOR ART

Today, Turkish coffee is made manually or automatically by means of various methods. The important criteria during cooking of the Turkish coffee are the correct adjustment of the Turkish coffee and the sugar, formation of foam in a firm manner and transfer of the foam to the cup in a firm manner and the occurrence of no overflow.

In the patent application TR2012/14652, a Turkish Coffee Cooking and Servicing System is disclosed. In said patent application, the servicing system is provided by means of a motor and a gear group. Due to the friction which occurs between the gear group; various noises occur and the piston defined in the system moves in a noisy manner. Since the gear group is made and mounted of more than one piece which needs sensitivity, the labor force consumption and the cost increase, and the production durations extend. Since there is a great number of pieces used in the system, the production and assembly durations increase. Moreover, the difficulty faced during assembly affects the production duration.

As a result, because of all of the abovementioned problems, an improvement is required in the related technical field.

### BRIEF DESCRIPTION OF THE INVENTION

The present invention relates to a Turkish coffee cooking and servicing machine, for eliminating the above mentioned disadvantages and for bringing new advantages to the related technical field.

The main object of the present invention is to provide a Turkish coffee cooking and servicing machine where noises occurring during operation are reduced.

Another object of the present invention is to provide a Turkish coffee cooking and servicing machine whose cost, production and assembly durations are reduced.

In order to realize all of the abovementioned objects and the objects which are to be deducted from the detailed description below, the present invention is a Turkish coffee cooking and servicing machine whose inner side is heated by means of a heater and having a cooking chamber wherein a coffee mixture including Turkish coffee, water and optionally sugar is cooked and having a pushing head defining the base of the cooking chamber and which moves vertically between at least one cooking position and a service position where the coffee mixture in the cooking chamber is raised to the level of the discharge outlet in order to transfer said coffee mixture, provided in the cooking chamber, to a beverage vessel through a discharge outlet for servicing when the cooking is completed. Accordingly, in order to move said pushing head between a cooking position and a servicing position, the subject matter Turkish coffee cooking and servicing machine is characterized by comprising at least one piston plate connected to the pushing head by means of a drive arm, at least one drive chamber wherein said piston plate is positioned in a movable manner, at least one pump which applies water through at least one lower hole and at least one upper hole into said drive chamber and thus which moves the pushing head, and at least one control unit which controls passage of water taken by said pump from the water depot and transferred to the drive chamber. Thus, in order to provide servicing of the cooked coffee, the pushing head moves in a silent manner between the cooking and servicing positions.

In a preferred embodiment of the subject matter invention, there is at least one first line providing water passage between the upper hole of the drive chamber and the water depot, and at least one fourth line providing water passage between the lower hole and the water depot.

In another preferred embodiment of the subject matter invention, there is at least one second line providing water passage between the upper hole of the drive chamber and the pump, and at least one third line for providing water passage between the lower hole and the pump.

In another preferred embodiment of the subject matter invention, there is at least one water feeding line extending between the pump and the cooking chamber.

In another preferred embodiment of the subject matter invention, the control unit comprises at least one control arm which can close and open the first line, the second line, the third line, the fourth line and the water feeding line.

In another preferred embodiment of the subject matter invention, in order to provide said control arm to open and close the first line, the second line, the third line, the fourth line and the water feeding line, there is at least one each control elements connected to each of the first line, the second line, the third line, the fourth line and the water feeding line.

In another preferred embodiment of the subject matter invention, the control elements are provided in the form of protrusions provided within a predetermined arrangement on the control arm.

In another preferred embodiment of the subject matter invention, the control arm is positioned in a substantially close manner on the first line, the second line, the third line, the fourth line and the water feeding line arranged side by side, and the control elements, provided on the control arm, open and close the first line, the second line, the third line, the fourth line and the water feeding line by means of the rotation of the control arm when desired.

In another preferred embodiment of the subject matter invention, at least the section of the first line, the second line, the third line, the fourth line and the water feeding line which is connected to the control arm is made of a substantially flexible material.

In another preferred embodiment of the subject matter invention, the control elements compress and elastically deform the first line, the second line, the third line, the fourth line and the water feeding line during the rotation of the control arm and the control elements block water passage.

In another preferred embodiment of the subject matter invention, there is at least one motor connected to the control arm.

The present invention is a Turkish coffee cooking and servicing method for a Turkish coffee cooking and servicing machine. Accordingly, there are the steps of:
transferring water to the cooking chamber by the pump by opening the water feeding line by the control arm in the position where the pushing head is in the cooking position,
cooking the coffee by the heater after addition of the Turkish coffee and optionally sugar,
opening the first line and the third line and closing the second line and the fourth line by the control unit, and thereby transferring the water, received from the water depot by the pump, to the drive chamber through the lower hole, and bringing the pushing head to the service position by the drive arm.

In another preferred embodiment of the subject matter invention, there is the step of returning the pushing head to the cooking position as the control unit opens the second line and the fourth line and closes the first line, the third line and the water feeding line and as the pump transfers the water, received from the water depot, to the drive chamber through the upper hole.

In another preferred embodiment of the subject matter invention, there is the step of returning the water, provided on the piston plate in the drive chamber, to the water depot during the passage of the pushing head to the service position.

In another preferred embodiment of the subject matter invention, there is the step of returning the water, remaining under the piston plate in the drive chamber, to the water depot during the passage of the pushing head to the cooking position.

### BRIEF DESCRIPTION OF THE FIGURES

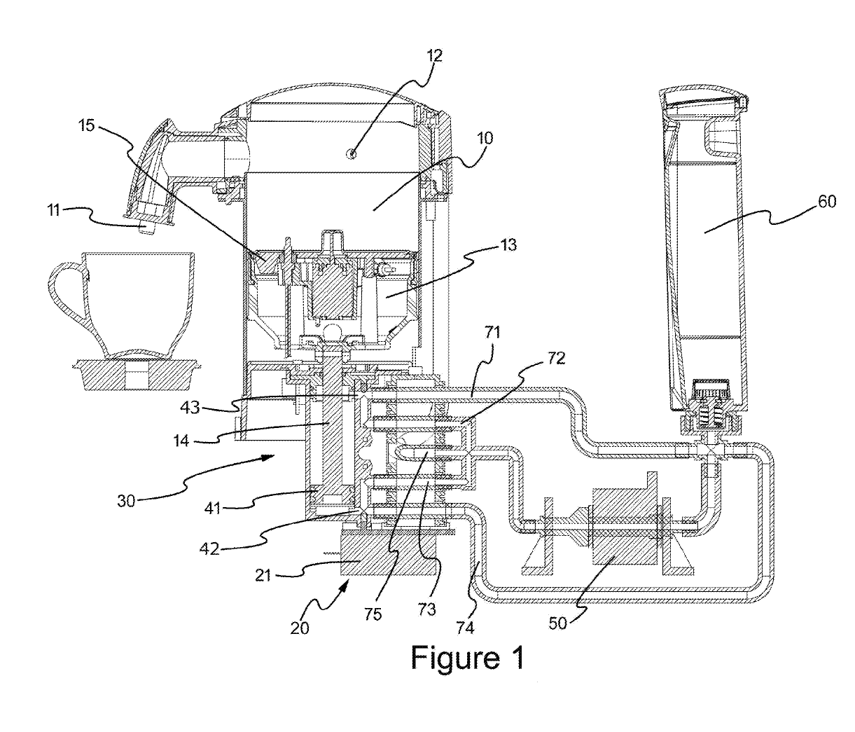

In FIG. 1, a representative general view of the subject matter Turkish coffee cooking and servicing machine is given where said machine is in waiting position.

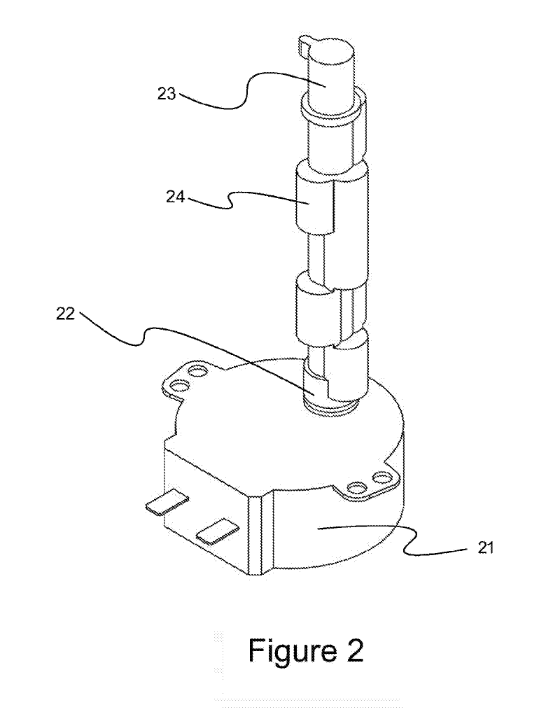

In FIG. 2, a representative view of the control unit of the subject matter Turkish coffee cooking and servicing machine is given.

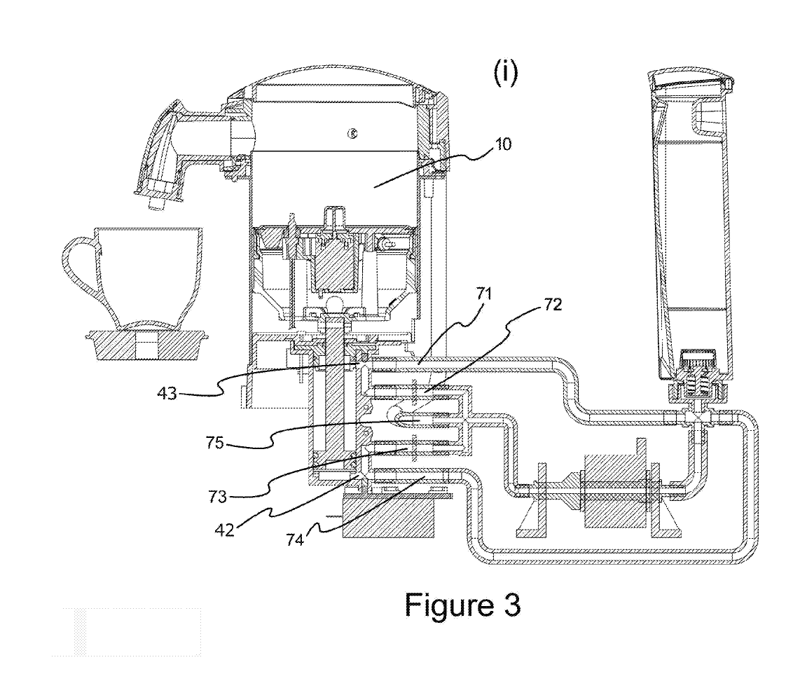

In FIG. 3, a representative view of the subject matter Turkish coffee cooking and servicing machine during preparation prior to cooking and at the cooking position (i) is given.

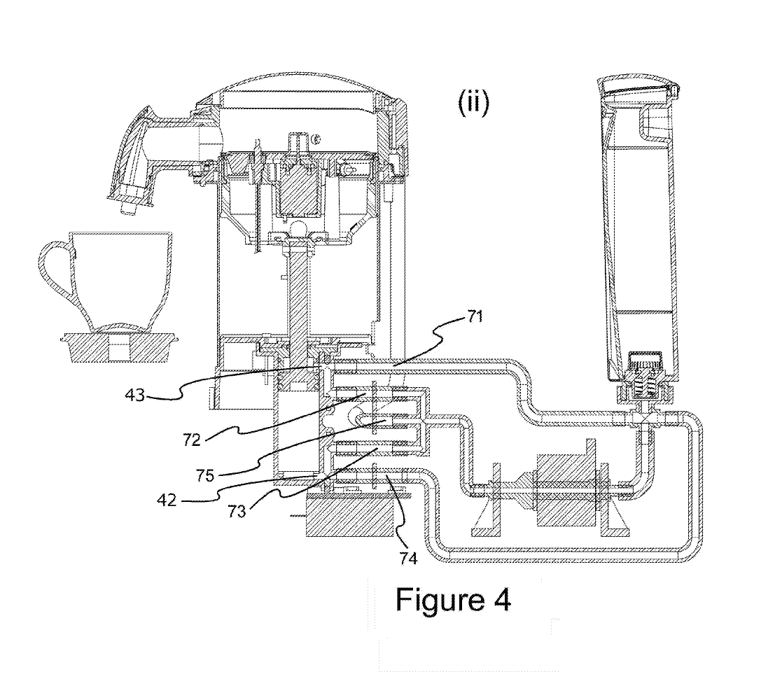

In FIG. 4, a representative view of the subject matter Turkish coffee cooking and servicing machine in the servicing position (ii) where coffee is serviced is given.

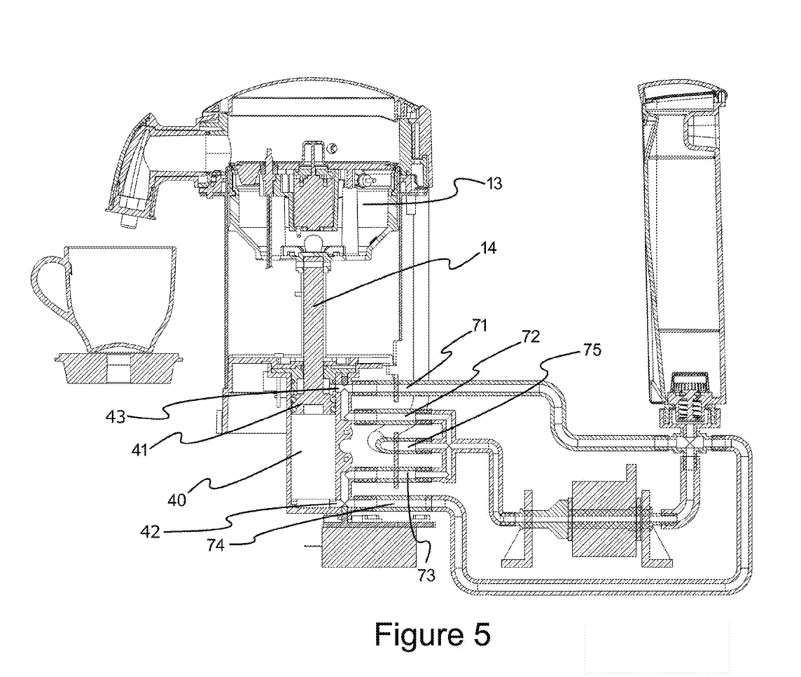

In FIG. 5, a representative view of bringing the subject matter Turkish coffee cooking and servicing machine to the ready-to-use condition after the servicing process is given.

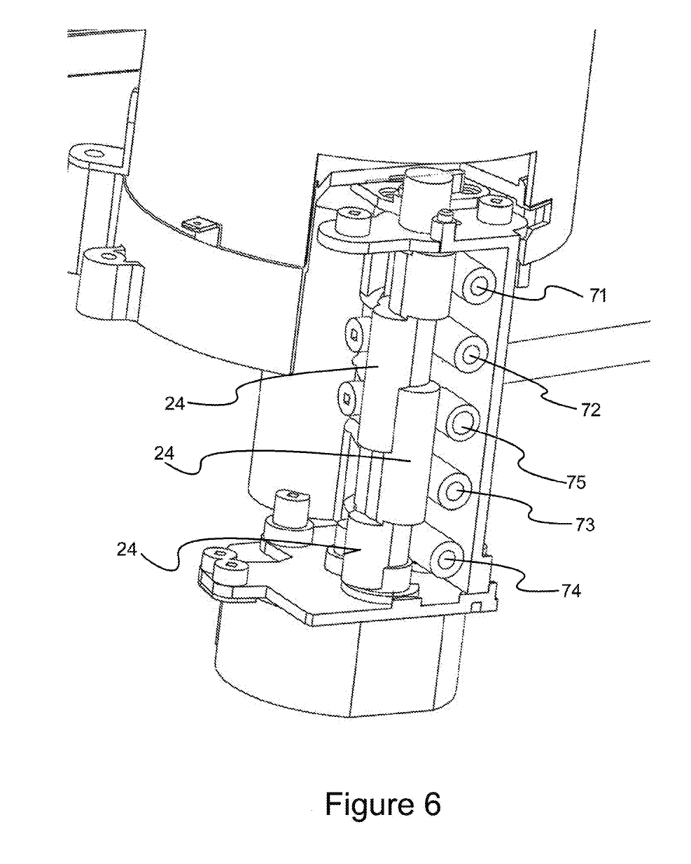

In FIG. 6, another representative view of the control unit of the subject matter Turkish coffee cooking and servicing machine is given.

REFERENCE NUMBERS

| | |
|---|---|
| 10 | Cooking chamber |
| 11 | Discharge outlet |
| 12 | Water feeding inlet |
| 13 | Pushing head |
| 14 | Drive arm |
| 15 | Heater |
| 20 | Control unit |
| 21 | Motor |
| 22 | Output shaft |
| 23 | Control arm |
| 24 | Control element |
| 30 | Drive unit |
| 40 | Drive chamber |
| 41 | Piston plate |
| 42 | Lower hole |
| 43 | Upper hole |
| 50 | Pump |
| 60 | Water depot |
| 71 | First line |
| 72 | Second line |
| 73 | Third line |
| 74 | Fourth line |
| 75 | Water feeding line |
| i | Cooking position |
| ii | Servicing position |

### THE DETAILED DESCRIPTION OF THE INVENTION

In this detailed description, the subject matter Turkish coffee cooking and servicing machine is explained with references to examples without forming any restrictive effect only in order to make the subject more understandable.

As can be seen in FIG. 1, the subject matter Turkish coffee cooking machine has a cooking chamber (10) wherein coffee is cooked and afterwards serviced. There is at least one discharge outlet (11) provided preferably on the side wall of the cooking chamber (10). Moreover, again preferably there is at least one water feeding inlet (12) provided on the side wall of the cooking chamber (10). Said water feeding inlet (12) is connected to at least one water depot (60) by means of at least one pump (50) and at least one water feeding line (75). In the preferred embodiment of the present invention, the water feeding inlet (12) is provided at a higher level than the discharge outlet (11). Inside the cooking chamber (10), there is at least one pushing head (13) which defines the base of the cooking chamber (10). In order to provide vertical movement of said pushing head (13) inside the cooking chamber (10), there is at least one drive unit (30), and there is at least one control unit (20) in order to control said drive unit (30). There is at least one heater (15) in order to provide realization of the cooking process in the cooking chamber (10).

Said drive unit (30) comprises at least one drive chamber (40), and at least one pump (50) connected to said drive chamber (40), and said water depot (60). There is at least one piston plate (41) provided inside the drive chamber (40). Said piston plate (41) is connected to the pushing head (13) by means of at least one drive arm (14). The piston plate (41) is vertically movable inside the drive chamber (40). On the drive chamber (40), there is at least one lower hole (42) and at least one upper hole (43) on different sides of the piston plate (41). There is at least one first line (71) extending from said upper hole (43) to the water depot (60) and through which water passes. Moreover, there is at least one second line (72) extending from said upper hole (43) to the pump (50) and through which water passes. There is at least one third line (73) extending from said lower hole (42) to the pump (50) and through which water passes. Moreover, there is at least one fourth line (74) extending from the lower hole (42) to the water depot (60) and through which water passes. The first line (71) and the second line (72) preferably join at a region which is close to the drive chamber (40), and they are connected as a single line to the upper hole (43). In a similar manner, the third line (73) and the fourth line (74) preferably join at a region which is close to the drive chamber (40), and they are connected as a single line to the lower hole (42).

As can be seen in FIGS. 1 and 2, said control unit (20) is connected to the first line (71), the second line (72), the third line (73), the fourth line (74) and the water feeding line (75). The control unit (20) has at least one motor (21), and at least one control arm (23) connected to the motor (21) by means of an output shaft (22). Said control arm (23) is connected to the first line (71), the second line (72), the third line (73), the fourth line (74) and the water feeding line (75). Pluralities of control elements (24) are provided on the control arm (23). Each of said control elements (24) is connected to the first line (71), the second line (72), the third line (73), the fourth line (74) and the water feeding line (75). In the preferred embodiment of the present invention, the control elements (24) are arranged on the control arm (23) in a non-linear manner. Accordingly, during the rotation of the motor (21), the control elements (24) on the control arm (23) provide the first line (71), the second line (72), the third line (73), the fourth line (74) and the water feeding line (75) to be opened and closed depending on the rotation amount of the control arm (23).

In the light of said structural details, the operation manner of the subject matter Turkish coffee servicing machine is as follows.

In the cooking position (i) shown in FIG. 3, the preparations prior to the cooking process and the cooking process are realized. Accordingly, the pushing head (13), provided in the cooking chamber (10), is at the bottom position, and it is ready to take water into the cooking chamber (10). Meanwhile, the control arm (23) closes the first line (71), the second line (72), the third line (73) and the fourth line (74). In other words, only the water feeding line (75) is in open position. As the pump (50) is activated, the water, taken from the water depot (60), passes through the water feeding line (75) and through the water feeding inlet (12), and it enters into the cooking chamber (10). Afterwards, Turkish coffee is cooked inside the cooking chamber (10).

As the pushing head passes to the service position (ii) illustrated in FIG. 4, the servicing process of the cooked Turkish coffee is realized. In order to provide this, the pushing head (13) moves vertically upwardly, and it pours the coffee outwardly through the discharge outlet (11). The vertical movement of the pushing head is provided by the drive unit (30). In more details, meanwhile, the control arm (23) rotates, and the first line (71) and the third line (73) are opened, and the second line (72) and the fourth line (74) are closed. Moreover, meanwhile, the water feeding line (75) is also closed. Thus, meanwhile, the water, applied by the pump (50), advances in the third line (73), and it enters into the drive chamber (40), and it pushes the piston plate (41) upwardly. The pushing head (13), connected to the piston plate (41) by means of the drive arm (14), moves upwardly simultaneously. Meanwhile, since the fourth line (74) is closed, the water, applied by the pump (50), is prevented from returning into the water depot (60). The water, entering into the drive chamber (40) through the lower hole (42), forces the piston plate (41) to move upwardly. By means of this, while the piston plate (41) moves upwardly, the water, provided on the upper side of the piston plate (41) in the drive chamber (40), exits the upper hole (43), and it advances to the water depot (60) through the first line (71). Moreover, since the second line (72) is closed meanwhile, water is prevented from being sent to the upper side of the piston plate (41) by the pump (50). Since the water feeding line (75) is closed, water is prevented from being sent to the cooking chamber (10).

After the Turkish coffee is serviced, the pushing head (13) shall lower and arrive at the first position, and it shall be prepared again for a new cooking process. In order to provide this, as illustrated in FIG. 5, the control arm (23) rotates further at a predetermined amount, and it opens the second line (72) and the fourth line (74). Moreover, it closes the first line (71), the third line (73) and the water feeding line (75). By means of this, the water, applied by the pump (50), passes through the second line (72), and it enters into the drive chamber (40) through the upper hole (43). Thus, the piston plate (41) is pushed downwardly. The pushing head (13) connected to the piston plate (41) by means of the drive arm (14) moves downwardly in a simultaneous manner. Meanwhile, the water, existing under the piston plate (41), returns to the water depot (60) through the fourth line (74). Since the third line (73) is closed, the water, applied by the pump (50), is prevented from arriving at the lower side of the piston plate (41). Moreover, since the first line (71) is closed, the water, applied by the pump (50), is prevented from reaching the water depot (60). Since the water feeding line (75) is closed, water is prevented from reaching the cooking chamber (10).

As can be seen in FIG. 6, in the preferred embodiment of the present invention, the first line (71), the second line (72), the third line (73), the fourth line (74) and the water feeding line (75) are made of pipes which can change shape elastically as a result of the forces exerted thereon. Thus, when the forces exerted thereon are removed, they return to their prior forms. By means of said embodiment, during the rotation of the control arm (23), the control elements (24), provided preferably in protrusion form on said control arm (23), exert pressure on the first line (71), the second line (72), the third line (73), the fourth line (74) and the water feeding line (75), and said control elements (24) close said lines (71, 72, 73, 74, 75) in a manner preventing water passage through them. By means of the non-linear distribution of the control elements (24) on the control arm (23), different lines can be open or closed at different times during the rotation of the control arm (23).

On the control arm (23), there is a linear space section where the control elements (24) do not exist. When said linear space section of the control arm (23) corresponds to the lines, no pressure is formed. In other words, the first line (71), the second line (72), the third line (73), the fourth line (74) and the water feeding line (75) are in open condition. As can be seen in FIG. 1, this position of the control arm (23) is defined as a waiting position. Thus, since there is no force on the pipes in this position, they are prevented from being deformed in times when the machine is not used. Moreover, the pump (50) is closed before they arrive at this position, and the pump (50) stops applying water. By means of this, uncontrolled water application is prevented.

By means of this whole embodiment, the vertical movement of the pushing head (13) is provided by a hydraulic drive unit (30). By means of this, there remains no need to use linear movement systems (screwed shaft, etc.) for providing said movement. Thanks to this, the Turkish coffee cooking and servicing machine can operate in a more silent manner.

By means of this whole embodiment, in the present art, there remains no need to use the gear group which is the movement transfer element.

Moreover, there remains no need to use the power supply unit which had to be used together with the motor & gear group which is used as the movement source. This means that the costs are reduced.

On the other hand, since the pump (50), used as the drive source, is used in the present art, the need for using additional piece is eliminated.

The protection scope of the present invention is set forth in the annexed Claims and cannot be restricted to the illustrative disclosures given above, under the detailed description. It is because a person skilled in the relevant art can obviously produce similar embodiments under the light of the foregoing disclosures, without departing from the main principles of the present invention.

1. A Turkish coffee cooking and servicing machine whose inner side is heated by means of a heater and having a cooking chamber wherein a coffee mixture including Turkish coffee, water and optionally sugar is cooked and having a pushing head defining the base of the cooking chamber and which moves vertically between at least one cooking position and a service position where the coffee mixture in the cooking chamber is raised to the level of the discharge outlet in order to transfer said coffee mixture, provided in the cooking chamber, to a beverage vessel through a discharge outlet for servicing when the cooking is completed, the subject matter Turkish coffee cooking and servicing machine is wherein comprising at least one piston plate connected to the pushing head by means of a drive arm, at least one drive chamber wherein said piston plate is positioned in a movable manner, at least one pump which applies water through at least one lower hole and at least one upper hole into said drive chamber and thus which moves the pushing head, and at least one control unit which controls passage of water taken by said pump from the water depot and transferred to the drive chamber.

2. A Turkish coffee cooking and servicing machine according to claim 1, wherein comprising at least one first line providing water passage between the upper hole of the drive chamber and the water depot, and at least one fourth line providing water passage between the lower hole and the water depot.

3. A Turkish coffee cooking and servicing machine according to claim 1, wherein comprising at least one second line providing water passage between the upper hole of the drive chamber and the pump, and at least one third line for providing water passage between the lower hole and the pump.

4. A Turkish coffee cooking and servicing machine according to claim 1, comprising at least one water feeding line extending between the pump and the cooking chamber.

5. A Turkish coffee cooking and servicing machine according to claim 1, wherein the control unit comprises at least one control arm which can close and open the first line, the second line, the third line, the fourth line and the water feeding line.

6. A Turkish coffee cooking and servicing machine according to claim 5, wherein in order to provide said control arm to open and close the first line, the second line, the third line, the fourth line and the water feeding line, there is at least one each control elements connected to each of the first line, the second line, the third line, the fourth line and the water feeding line.

7. A Turkish coffee cooking and servicing machine according to claim 6, wherein the control elements are provided in the form of protrusions provided within a predetermined arrangement on the control arm.

8. A Turkish coffee cooking and servicing machine according to claim 7, characterized in that wherein the control arm is positioned in a substantially close manner on the first line, the second line, the third line, the fourth line and the water feeding line arranged side by side, and the control elements, provided on the control arm, open and close the first line, the second line, the third line, the fourth line and the water feeding line by means of the rotation of the control arm when desired.

9. A Turkish coffee cooking and servicing machine according to claim 5, wherein at least the section of the first line, the second line, the third line, the fourth line and the water feeding line which is connected to the control arm is made of a substantially flexible material.

10. A Turkish coffee cooking and servicing machine according to claim 9, wherein the control elements compress and elastically deform the first line, the second line, the third line, the fourth line and the water feeding line during the rotation of the control arm and the control elements block water passage.

11. A Turkish coffee cooking and servicing machine according to claim 10, wherein comprising at least one motor connected to the control arm.

12. A Turkish coffee cooking and servicing method for a Turkish coffee cooking and servicing machine according to claim 1, wherein comprising the steps of:
transferring water to the cooking chamber by the pump by opening the water feeding line by the control arm in the position where the pushing head is in the cooking position,
cooking the coffee by the heater after addition of the Turkish coffee and optionally sugar,
opening the first line and the third line and closing the second line and the fourth line by the control unit, and thereby transferring the water, received from the water depot by the pump, to the drive chamber through the lower hole, and bringing the pushing head to the service position by the drive arm.

13. A Turkish coffee cooking and servicing method according to claim 12, wherein comprising the step of returning the pushing head to the cooking position as the control unit opens the second line and the fourth line and closes the first line, the third line and the water feeding line and as the pump transfers the water, received from the water depot, to the drive chamber through the upper hole.

14. A Turkish coffee cooking and servicing method according to claim 12, wherein comprising the step of returning the water, provided on the piston plate in the drive chamber, to the water depot during the passage of the pushing head to the service position.

15. A Turkish coffee cooking and servicing method according to claim 13, wherein comprising the step of returning the water, remaining under the piston plate in the drive chamber, to the water depot during the passage of the pushing head to the cooking position.
